(19) United States
(12) Patent Application Publication
(10) Pub. No.: US 2019/0057439 A1
(43) Pub. Date: Feb. 21, 2019

(54) ASSISTING SHOPPERS FOR CLOTHING ITEMS

(71) Applicant: INTERNATIONAL BUSINESS MACHINES CORPORATION, ARMONK, NY (US)

(72) Inventors: YUK L. CHAN, ROCHESTER, NY (US); HEIDI LAGARES-GREENBLATT, JEFFERSON HILLS, PA (US); DEEPTI M. NAPHADE, SAN JOSE, CA (US)

(21) Appl. No.: 15/677,248

(22) Filed: Aug. 15, 2017

(51) Int. Cl. G06Q 30/06; G06F 17/30

(52) U.S. Cl. CPC G06Q 30/0643; G06Q 30/0623; G06F 17/30256

(57) ABSTRACT

Embodiments include methods, systems and computer program products for providing a visualization of how a user will look in a clothing item is provided. Aspects include receiving, from a user, a request for a visualization of the user in an item of clothing and obtaining, by a processing system, a profile of the user. Aspects also include identifying, by the processing system, a plurality of candidates from a database, wherein each of the plurality of candidates has a user profile that includes a picture of an individual wearing the item of clothing. Aspects further include analyzing, by the processing system, each the plurality of candidates to create a confidence score reflecting a similarity of a physical appearance of each of the plurality of candidates with the user. Aspects also include providing, to the user, images of one or more of the plurality of candidates in the item of clothing.

### BACKGROUND

The present disclosure relates to the field of shopping, and more specifically, to assisting shoppers for clothing items in determining how they will look in various items of clothing.

When shopping for clothing, particularly during online shopping, it can be difficult for a shopper to determine how an item of clothing will look on their body. While pictures of people wearing the clothing item may be available for the shopper to view. Many retailers use images of beautiful models wearing clothing items to display how the clothes look on people. These images often do not reflect how a clothing item will look on a shopper because the shopper may have a different body type that the model shown in the image.

### SUMMARY

In accordance with one embodiment, a computer-implemented method for providing a visualization of how a user will look in a clothing item is provided. The method includes receiving, from a user, a request for a visualization of the user in an item of clothing and obtaining, by a processing system, a profile of the user. The method also includes identifying, by the processing system, a plurality of candidates from a database, wherein each of the plurality of candidates has a user profile that includes a picture of an individual wearing the item of clothing. The method further includes analyzing, by the processing system, each the plurality of candidates to create a confidence score reflecting a similarity of a physical appearance of each of the plurality of candidates with the user. The method also includes providing, to the user, images of one or more of the plurality of candidates in the item of clothing.

In accordance with one embodiment, a system having at least one processor and a memory, operably coupled to the at least one processor is provided. The memory storing processor computer readable instructions and the at least one processor is configured to execute computer readable instructions, which cause the processor to receive, from a user, a request for a visualization of the user in an item of clothing and obtain a profile of the user. The computer readable instructions also cause the processor to identify a plurality of candidates from a database, wherein each of the plurality of candidates has a user profile that includes a picture of an individual wearing the item of clothing. The computer readable instructions also cause the processor to analyze each the plurality of candidates to create a confidence score reflecting a similarity of a physical appearance of each of the plurality of candidates with the user. The computer readable instructions also cause the processor to provide, to the user, images of one or more of the plurality of candidates in the item of clothing.

In accordance with one embodiment, a computer program product, the computer program product comprising a computer readable storage medium having program instructions embodied therewith, the program instructions executable by a processor to cause the processor to receive, from a user, a request for a visualization of the user in an item of clothing and obtain a profile of the user. The program instructions also cause the processor to identify a plurality of candidates from a database, wherein each of the plurality of candidates has a user profile that includes a picture of an individual wearing the item of clothing. The program instructions further cause the processor to analyze each the plurality of candidates to create a confidence score reflecting a similarity of a physical appearance of each of the plurality of candidates with the user. The program instructions also cause the processor to provide, to the user, images of one or more of the plurality of candidates in the item of clothing.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings, in which:

FIG. 1 illustrates an example of a computer system in accordance with one or more embodiments of the present invention;

FIG. 2 illustrates another exemplary system in accordance with one or more embodiments of the present invention; and

FIG. 3 illustrates an example of a method in accordance with one or more embodiments of the present invention.

### DETAILED DESCRIPTION

Embodiments of the present disclosure include systems, computer program products, and methods for assisting shoppers for clothing items in determining how they will look in various items of clothing. In exemplary embodiments, individuals will be able to visualize how a clothing item will look on their body by viewing images of similarly shaped individuals wearing the clothing item, or similar clothing items. In exemplary embodiments, a user will create a profile that can include various measurements of the user and images of the user wearing various types of clothing items.

In exemplary embodiments, upon receiving a request from a user that includes a desired clothing item, a database of users is searched to identify one or more images that depict individuals wearing the desired clothing item. Next, a confidence level that represents a similarity of a physical appearance between the depicted individuals and the user is calculated. The one or more images that depict individuals wearing the desired clothing item that have the highest confidence levels are then presented to the user.

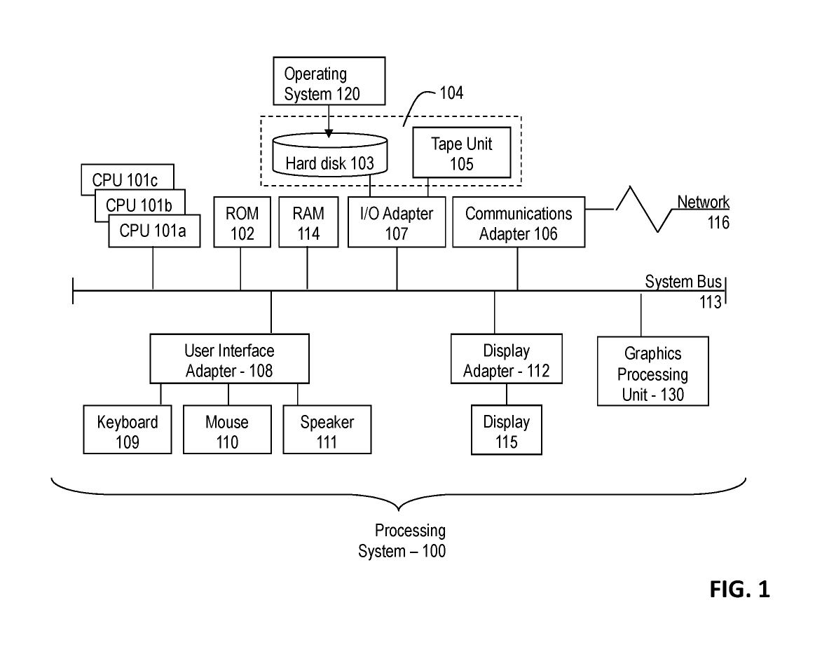

FIG. 1 illustrates an example of a computer system in accordance with one or more embodiments of the present invention. As shown, a processing system 100 one or more central processing units (processors) 101a, 101b, 101c, etc. (collectively or generically referred to as processor(s) 101). In one or more embodiments, each processor 101 may include a reduced instruction set computer (RISC) microprocessor. Processors 101 are operably coupled to various components of system 100 via system bus 113. Read only memory (ROM) 102 is coupled to the system bus 113 and may include a basic input/output system (BIOS), which controls certain basic functions of system 100.

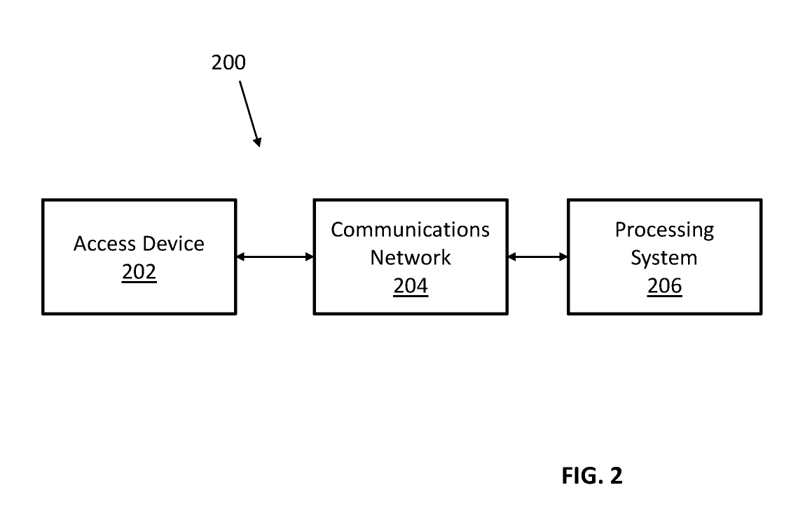

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with network 116 enabling system 100 to communicate with other (internal or external) systems (not depicted). In some embodiments, network 116 can be a communications network 204 (FIG. 2).

Referring again to FIG. 1, a screen (e.g., a display monitor) 115 is connected to system bus 113 by display adaptor 112, which may include a graphics adapter to improve the performance of graphics intensive applications and a video controller. In one or more embodiments, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters, which may include protocols, such as the Peripheral Component Interconnect (PCI) protocol. Additional exemplary input/output devices are shown as connected to system bus 113 via user interface adapter 108 and display adapter 112. In one or more embodiments, keyboard 109, mouse 110, and speaker 111 are all interconnected to bus 113 via user interface adapter 108, which may be embodied (by way of example only) as multiple device adapters (not depicted) or may combine one or more device adapters into a single integrated circuit (sometimes referred to as a super I/O chip).

Thus, as illustrated in FIG. 1, processing system 100 includes: processing capability in the form of processors 101; memory in the form of ROM 102, RAM 114 (sometimes referred to as system memory) and mass storage 104; input means in the form of keyboard 109 and mouse 110; and output capability in the form of speaker 111 and display 115. In one or more embodiments, a portion of system memory 114 and mass storage 104 collectively store an operating system, whose functions can include coordination of various system components. The memory can also store one or more applications, that when executed by the processor 101, perform one or more methods of the present invention.

Referring to FIG. 2, a system 200 in accordance with one or more embodiments of the present invention. In some embodiments, the system 200 can be implemented as a client-server architecture. As depicted, the system 200 includes a, access device 202 in communication with a processing system 206 via a communications network 204. In some embodiments, the access device 202 can be a mobile device, such as a mobile phone that is operably coupled to processing system 206 via communications network 204. In some embodiments, processing system 206, can embody aspects of system 100 depicted in FIG. 1, in which the user device 202 accesses the processing system 206 via hard-wired e.g., “Ethernet” and/or wireless e.g., “cellular” or “Wifi” aspects of network 116. In some embodiments, processing system 206, can be partly (or entirely) embodied in a so-called “cloud” environment associated with network 204. In some embodiments, communications network 204 can include an internal local area network (LAN) and/or a public communications network such as the Internet, or a combination of various networks.

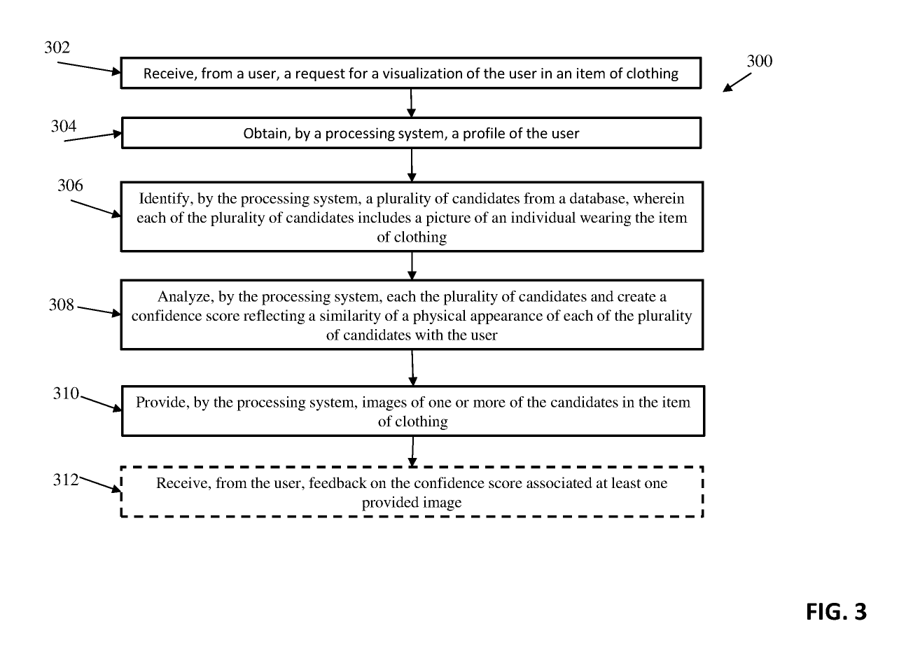

Referring to FIG. 3, a flowchart of a method 300 for assisting shoppers for clothing items in determining how they will look in various items of clothing in accordance with one or more embodiments of the present invention. As illustrated, at block 302, the method 300 includes receiving, from a user, a request for a visualization of the user in an item of clothing. In exemplary embodiments, the request can be received based on a user selecting a clothing item on a website, a user capturing an image of a tag of a clothing item with a mobile device, a user capturing an image of the clothing item with a mobile device, or the like. Next, the method 300 includes obtaining, by a processing system, a profile of the user, as shown at block 304. In exemplary embodiments. The profile of the user can include measurements of the user, such as height, weight, waist size, inseam, chest size, neck size, leg length, and the like. In addition, the profile of the user can include one or more images of the user wearing various clothing items. In exemplary embodiments, the one or more images of the user can be analyzed to create estimates of the measurements of the user if the user has not provided measurements or complimenting the user provided measurement.

Continuing with reference to FIG. 3, the method 300 also includes identifying, by the processing system, a plurality of candidates from a database, wherein each of the plurality of candidates includes a picture of an individual wearing the item of clothing, as shown at block 306. In one embodiment, identifying the plurality of candidates from the database includes performing image analysis to identify the item of clothing in images stored in the database. In another embodiment, the images stored in the database include metadata regarding clothing items depicted and identifying the plurality of candidates from the database includes searching the metadata using information provided in the request. The metadata regarding clothing items depicted can include a size of the clothing item depicted, the manufacture of the clothing item depicted, the style or cut of the clothing item depicted, the type of material that the clothing item depicted is made of, and the like.

As shown at block 308, the method 300 includes analyzing, by the processing system, each the plurality of candidates and creating a confidence score reflecting a similarity of a physical appearance of each of the plurality of candidates with the user. In one embodiment, analyzing each the plurality of candidates to create the confidence score includes comparing the one or more measurements of the user with measurements associated with the plurality of candidates. The confidence score is calculated such that the closer the measurements of the user are to the measurements of a candidate, the higher the confidence score will be. In another embodiment, analyzing each the plurality of candidates to create the confidence score comprises performing image classification algorithm on the images in the user profile of each of the plurality of candidates and one or more images of the user.

In another embodiment, the confidence score can be determined from a photo of the user and candidate wearing the same clothing. For example, with a frontal photo of the user wearing a T-Shirt from brand A, size small, color black, and a frontal photo of a candidate wearing the same T-Shirt (from brand A, size small, color black). The confidence score can be determined by analyzing the differences between the photo of the user and candidate. The differences could be a combination of the measured width of the shoulder and waist on the photo, the measured width of the upper arm, the ratio of width of shoulder to waist, the ratio of width of the neck to the collar, the ratio of the width of upper arm to the sleeve, the relative gradient shade from chest to waist, the percentage of pixel different between the T-shirts in the two photos when the T-shirts are scaled to each other's size and overlapped etc. The differences are not limited by the method of comparison, as long as the photos are comparable.

In the case that the photos are not directly comparable, computational transformation can be performed on the photo, and a weight will be applied to the confidence level to account for error introduced by the transformation. For example, the upper right of a T-shirt of a photo might be slanted toward the right by 5 degrees. The candidate's photo can be transformed using a combination of one or more image processing techniques such as “perspective transformation”, “affine transformation”, “rotation”, “translation” etc. These transformations will turn the candidate photo into a comparable photo with the user's photo. Depending on the type of transformation and the degree of transformation applied, the confidence score can be adjusted by a weight to compensate for the potential error. For example, a “translation” simply shift the image from one position to another, while an “affine transformation” change a distorted image. Since a “translation” is unlikely to introduce an error, the confidence score will be scaled by a weight of 1, resulting in the same confidence score. On the other hand, an “affine transformation” is likely to introduce more error than “translation” or “rotation”, the confidence score will be scaled by a smaller weight such as 0.75, resulting in a lower confidence score.

In another embodiment, the photo being analyzed can contain different clothing. For example, certain T-shirts from the same designer might have similar cuttings, even though, they are different T-shirt. Another example, the same T-shirt different size might be comparable. The differences between size, cutting can be learned over time. For example, user A has T-shirt X, and she also has T-shirt Y from the same designer. It can be assumed that T-shirt X and T-shirt Y has similar characteristics that fit the same user. Furthermore, the differences between photo with T-shirt X and T-shirt Y and the same user can be analyzed as suggested above, to better determine the similarity of characteristics. Using this technique, the similarity of cuttings from the same designer can be determined (e.g. 90% of T-shirt from this designer is similar to each other.) This technique can be used to find a matching candidate. This candidate might have a photo with T-shirt Z by the same designer as T-shirt X and T-shirt Y. This photo with T-shirt Z from this candidate can be compared with the photo of the user with T-shirt X. This technique can be applied to different sizes of the same T-shirt, different T-shirts, different T-shirt with different sizes, or other characteristics of a clothing item. Furthermore, when comparing different but similar clothing item, a weight can be applied to adjust the confidence level and account for the possibility of errors.

In another embodiment, the photo being analyzed can capture the side, the back or any position of a person. The different position could contribute to different weight. For example, a frontal image comparison could have a larger weight compare to an image of the back. On the other hand, multiple images of a different position from the same person could improve the confidence score of matching. For example, a candidate with front photo 80% confidence score, and side photo with 80% confidence score might result in an overall higher confidence score at 85%.

The matching of a candidate can use a combination of metadata and image analysis technique. For example, the photo might contain the brand name of a T-shirt in string format in the metadata. This brand name can be used to identify the photo, where further image analysis technique can be applied to the identified photo. Both the metadata and image analysis result can be used to determine the confidence score. For example, the metadata can contribute to 60% of the overall confidence score, while the result of image analysis can contribute to 40% of the overall confidence score. The contribution of metadata and image analysis can be different for different type of clothing (T-shirt vs a long dress), different ethnic group, different retail store, different brand, different size of clothing etc. This contribution can also be learned over time, based on the feedback loop (i.e. whether the candidate photo reflects the user well) from the matching system.

In another embodiment, the feedback loop can be acquired from the user and user's surrounding information. For example, T-shirt A on a photo with a user and a photo with a candidate has a high confidence score (i.e. they are similar). The candidate has a photo with T-shirt B, which is a T-shirt that the user is considering. The feedback from the user can be collected (e.g. as a questionnaire) when the photo of the candidate is presented to the user. The feedback can also be collected after the user purchased the photo, and provide feedback on whether the user “likes” T-shirt B. The feedback will also consider if the candidate and user “likes” T-shirt A. For example, if the user doesn't like T-shirt A, the user doesn't like the candidate photo with T-shirt B, and the user also doesn't like T-shirt B, then the selected candidate photo is a good match. In another example, if the user like T-shirt A, the user like the candidate photo with T-shirt B, but the user doesn't like T-shirt B, then the selected candidate is not a good match. This can further trigger an adjustment of the image analysis technique, the weight applied, the relative weight of using differences from metadata and image analysis.

Next, as shown at block 310, the method 300 includes providing, by the processing system, images of one or more of the candidates in the item of clothing. In one embodiment, the images can be provided to the user by displaying the images in a pop-up window on their computer or mobile device that they are using for online shopping. In another embodiment, the images can be provided to the user by displaying the images on a display screen in the store in which the user is physically shopping. In exemplary embodiments, the images are provided to the user with one or more facial features of individuals in the images obscured.

In one embodiment, images of one or more of the candidates in the item of clothing are presented in order of the confidence score. In one embodiment, images that have a confidence level over a threshold value can be displayed. In another embodiment, a specific number of images that have the highest confidence level can be provided. In exemplary embodiments, the images of one or more of the plurality of candidates in the item of clothing can be provided to the user with the confidence score. For example, the image can be provided with a score overlaid on a portion of the display. The score can be a zero to one hundred score, a zero to ten score, with a higher number reflecting a higher degree of similarity of a physical appearance of each of the plurality of candidates with the user.

Optionally, the method 300 can include receiving, from the user, feedback on the confidence score associated with the at least one provided image, as shown at block 312. This feedback can be used to adjust the confidence score between the user and the profile associated with the provided image. In exemplary embodiments, the method can also include receiving an image of the user in the clothing item and updating the profile of the user to include the image. For example, if a user in a store views images of other individuals in the clothing item and decides to try on the item, an image of the user in the clothing item can be captured and uploaded to the user profile.

In exemplary embodiments, stores or clothing manufacturers may use similar design patterns or cuts for multiple clothing items, the system can be configured to display images of clothing items that have similar profiles (not only identical items) in order to have more images to provide. This system could work at the online level but could also be integrated with technical systems in stores to show buyers these items at the physical stores too. People who have purchased or tried clothes have a history of clothing through their personal photos or social media or maybe even photos they are willing to share with merchants. These photos can be stored with a tag on each of the items based on the person and their measurements/profile.

In one embodiment, a store (online or physical) can have indicators when a person is looking or interested in items and they can show them what these items will look like on them. This can be done by previously saved profiles or image processing. In addition to that, if they have friends that have tried these items (preferably friends with similar built), the system can also show some of the friends who have purchased and/or photograph themselves with these items.

In one embodiment, additional information can be determined about the clothing that a user is interested in. For example, the user is interested in T-shirt A and had a photo with T-shirt B. A candidate with a high confidence score photo with T-shirt B is identified. When a photo of the candidate with T-shirt A is shown to the user, the linkage (i.e. T-shirt B or other meta data) can also be shown to the user. If the candidate looks similar in T-shirt A and T-shirt B and the user doesn't like T-shirt B, then this might mean the user will not like T-shirt A (because this is similar to T-shirt B). This information can be presented to the user, used to select an advertisement for the user (e.g. maximize the conversion rate), or used by the retailer to reduce return or exchange.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically identified device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, micro-identifier, firmware instructions, state-setting data, or either source identifier or object identifier written in any combination of one or more programming languages, including an object-oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), a wireless LAN (WLAN using WiFi), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
receiving, from a user, a request for a visualization of the user in an item of clothing;
obtaining, by a processing system, a profile of the user;
identifying, by the processing system, a plurality of candidates from a database, wherein each of the plurality of candidates has a user profile that includes a picture of an individual wearing the item of clothing;
analyzing, by the processing system, each the plurality of candidates to create a confidence score reflecting a similarity of a physical appearance of each of the plurality of candidates with the user; and
providing, to the user, images of one or more of the plurality of candidates in the item of clothing.

2. The computer-implemented method of claim 1, further comprising receiving an image of the user in the clothing item and updating the profile of the user to include the image.

3. The computer-implemented method of claim 1, wherein the profile of the user includes one or more images of the user and one or more measurements of the user.

4. The computer-implemented method of claim 1, wherein analyzing each the plurality of candidates comprises comparing metadata of the user with metadata associated with each of the plurality of candidates.

5. The computer-implemented method of claim 1, wherein identifying the plurality of candidates from the database includes performing image analysis to identify the item of clothing in images stored in the database.

6. The computer-implemented method of claim 1, wherein the images of one or more of the plurality of candidates in the item of clothing are provided to the user with one or more of the confidence score and metadata associated the one or more of the plurality of candidates.

7. The computer-implemented method of claim 6, further comprising receiving from the user feedback on the confidence score provided for at least one of the one or more images of the clothing item.

8. The computer-implemented method of claim 1, wherein the images are provided to the user with one or more facial features of individuals in the images obscured.

9. The computer-implemented method of claim 1, wherein analyzing each the plurality of candidates to create the confidence score comprises performing image classification algorithm on the images in the user profile of each of the plurality of candidates and one or more images of the user.

10. A system comprising:
at least one processor
a memory, operably coupled to the at least one processor, the memory storing processor computer readable instructions;
the at least one processor, configured to execute computer readable instructions, which cause the processor to:
receive, from a user, a request for a visualization of the user in an item of clothing;
obtain a profile of the user;
identify a plurality of candidates from a database, wherein each of the plurality of candidates has a user profile that includes a picture of an individual wearing the item of clothing;
analyze each the plurality of candidates to create a confidence score reflecting a similarity of a physical appearance of each of the plurality of candidates with the user; and
provide, to the user, images of one or more of the plurality of candidates in the item of clothing.

11. The system of claim 10, wherein the at least one processor is further configured to receive an image of the user in the clothing item and update the profile of the user to include the image.

12. The system of claim 10, wherein the profile of the user includes one or more images of the user and one or more measurements of the user.

13. The system of claim 10, wherein analyzing each the plurality of candidates comprises comparing metadata of the user with metadata associated with each of the plurality of candidates.

14. The system of claim 10, wherein identifying the plurality of candidates from the database includes performing image analysis to identify the item of clothing in images stored in the database.

15. The system of claim 10, wherein the images of one or more of the plurality of candidates in the item of clothing are provided to the user with one or more of the confidence score and metadata associated the one or more of the plurality of candidates.

16. The system of claim 15, wherein the at least one processor is further configured to receive from the user feedback on the confidence score provided for at least one of the one or more images of the clothing item.

17. The system of claim 10, wherein the images are provided to the user with one or more facial features of individuals in the images obscured.

18. The system of claim 10, wherein analyzing each the plurality of candidates to create the confidence score comprises performing image classification algorithm on the images in the user profile of each of the plurality of candidates and one or more images of the user.

19. A computer program product, the computer program product comprising a computer readable storage medium having program instructions embodied therewith, the program instructions executable by a processor to cause the processor to:
receive, from a user, a request for a visualization of the user in an item of clothing;
obtain a profile of the user;
identify a plurality of candidates from a database, wherein each of the plurality of candidates has a user profile that includes a picture of an individual wearing the item of clothing;
analyze each the plurality of candidates to create a confidence score reflecting a similarity of a physical appearance of each of the plurality of candidates with the user; and
provide, to the user, images of one or more of the plurality of candidates in the item of clothing.

20. The computer program product of claim 19, wherein the profile of the user includes one or more images of the user and one or more measurements of the user.
